(19) United States
(12) Patent Application Publication
(10) Pub. No.: US 2023/0303458 A1
(43) Pub. Date: Sep. 28, 2023

(54) Mixing Concrete by the Yard (MCbtY)

(71) Applicant: Hector Padilla Mercado, Escondido, CA (US)

(72) Inventor: Hector Padilla Mercado, Escondido, CA (US)

(21) Appl. No.: 18/158,850

(22) Filed: Jan. 24, 2023

Related U.S. Application Data
(60) Provisional application No. 63/308,562, filed on Feb. 10, 2022.

(51) Int. Cl. C04B 40/06; C04B 28/02; C04B 14/06

(52) U.S. Cl. CPC C04B 40/0608; C04B 28/02; C04B 14/06

(57) ABSTRACT

A process for mixing concrete onsite in quantities of 1-yard or more, which makes use of the embodiment of a large industrial bag similar to those used for waste management of rubbish and an overhead rail system adapted to a dump trailer, which suspends the bag from straps attached to the bag and pined to the rail system. The four-sided system of columns and rails adapted to the trailer allows two of the four rails to be moved using winches, allowing mixing of the aggregate, cement and water without the use of metallic blades and rotating containers. The winch draws one rail attached to one side of the bag and releases and the opposing winch draws and releases the opposing rail attached to the opposing side of the bag. The bag allows the material to be placed away from the locked gates and opened for unloading concrete.

### BACKGROUND

Mixing concrete for yourself on-site in substantial volume has always been by means of concrete mixers capable of mixing ⅓-cubic yards or less or in a wheelbarrow or in a tub using mixing tools and manual labor. A full yard of concrete may be bought and moved with a cart-away concrete trailer, however, for multiple yards of concrete the next level up is to order a ready-mix cement truck load of up to 10-yards (typically). These methods of 1-yard or greater involve equipment not suitable for mixing onsite.

The present invention is directed to a process of mixing materials (gravel, sand cement and water) on site in quantities of one (1) cubic yard or more (twenty-seven cubic feet, typically called a “yard”). Although, mixing smaller quantities is possible with this invention, the known processes currently in the market makes use of a hand-held bag or a hand-held plastic sheet to mix smaller quantities involving a “ready mix” bag of 40-pounds, 60-pounds or even 90-pounds in weight. These current market methods are not suitable for a 1-yard volume due to the excessive weight of a yard of concrete.

The present invention embodiments incorporate a container, a large composite bag with straps, a means of rails attached to the container that suspend the bag by means of pins on the straps, which, maintain the bag flexible and suspended in the container, thus allowing movement of the bag to cause the contents to mix due to the displacement and turbulence of the material as the bag is pulled one way and the other way.

### BRIEF SUMMARY OF THE INVENTION

An embodiment for mixing solid and liquid materials is disclosed along with the process details for the production of a homogeneous mixed slurry, which typically may be concrete comprising of rock, sand, cement and water.

A method may include overhead conveyor rails typically used for the movement of assembled components, for example, are attached around the perimeter of a strong container by means of columns. The container has first a closed bottom, and adjoining vertical sides with the top-side opened to receive materials.

A composite bag with straps attached around the perimeter having the desired material strength and about the same dimensional configuration as the container is placed inside the container and the perimeter of the bag-straps are attached and pinned, on the outward strap end, to rollers or other sliding mechanisms, which, may be contained in the rails. In the case of a box, two of the rails are fixed, each opposite of each other, and the two remaining, each opposite of each other, are movable. However, the embodiment of the invention in scope, for a box, is not limited to just two of the four rails being movable or fixed.

The nature of mixing concrete in 1-yard quantities may require mechanical assistance. The assistance may include winches, however lead-screws; hydraulic pistons, and cylinders; and balanced weights may also be suitable to draw the bag filled to one-half of its volume capacity. The winches may be mounted on beams spanning from fixed-end to fixed-end, bridging the movable rails.

The winch mechanism pulls the bag end attached to one of the movable rails and releases, then, the opposing winch pulls the opposing movable rail and then releases. This action moves the material in waves thus causing the material to fold and roll over itself. This process is repeated until an acceptable mix is obtained.

The conveyer system is commercially available such as those provided the company Unibilt®. The composition of the bag is from known materials such as those used in the waste management commercial business; further, the bag can be made of rubber coated canvas or a number of other commercial composites. The straps are typically nylon but can also be made of varied commercial materials like leather or composite metals and plastics.

### BRIEF DESCRIPTION OF THE DRAWINGS

The following figures depict only typical embodiments of the invention and are not therefore to be considered to be limiting of its scope, the invention will be described and explained along with the accompanying figures in which:

FIG. 1 illustrates a two-sided elevation view and a top view of a typical dump trailer with a bag on the inside, suspended from straps to a rail system. Two winches are placed opposite of each other to assist in the mixing process of the dry and liquid materials placed in the bag. An exploded view, FIG. 1A, to the left of the top view shows the finer details of the embodiments.

FIG. 2 illustrates the initial pull on the bag by the first winch to start the material mixing process.

FIG. 3 illustrates the continued pull on the bag by the first winch to continue the mixing process.

FIG. 4 illustrates, in the mixing process, the end of the pull on the bag by the first winch.

FIG. 5 illustrates the release of the first winch to allow return of the bag to its initial position.

FIG. 6 illustrates the continued release of the first winch to allow return of the bag to its initial position.

FIG. 7 illustrates the final position of the bag to its initial position.

FIG. 8 illustrates the initial pull on the opposite side of the bag by the second winch.

FIG. 9 illustrates the continued pull on the opposite side of the bag by the second winch to continue the mixing process.

FIG. 10 illustrates, in the mixing process, the end of the pull on the bag by the second winch.

FIG. 11 illustrates the bag inside the trailer, in three views: two elevation (side and back) and one top view. FIG. 11 shows the support strap grid attached to the rail system and a way of folding the bag under itself to allow flow of material during the off-loading process.

### DETAILED DESCRIPTION AND BEST MODE OF IMPLEMENTATION

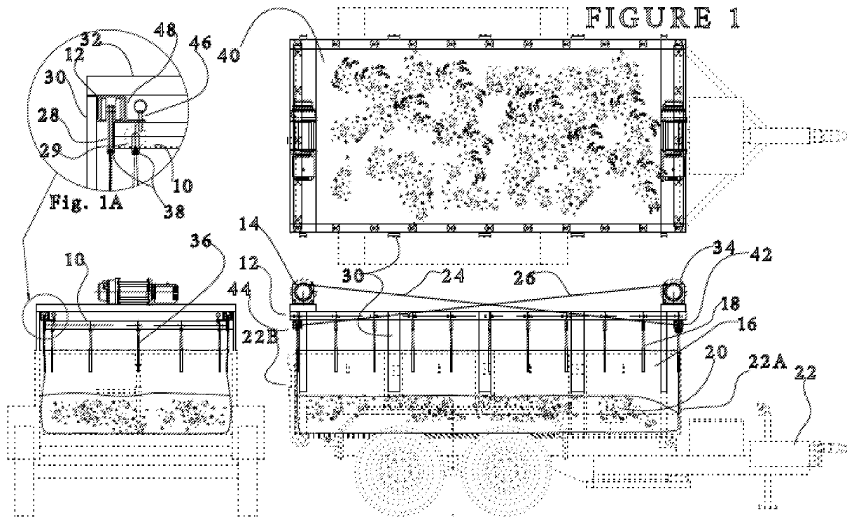

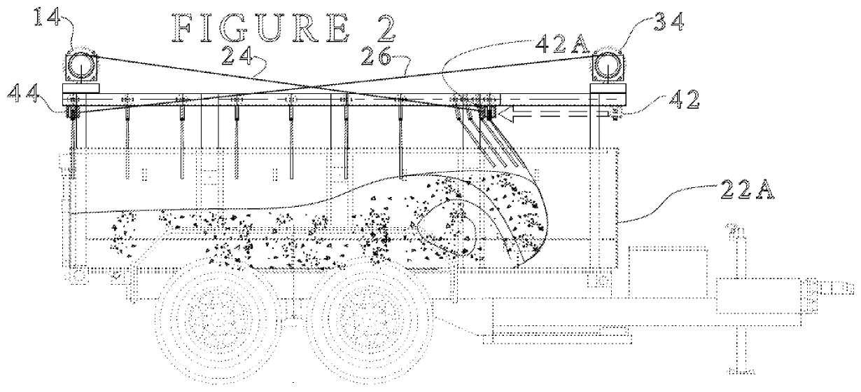

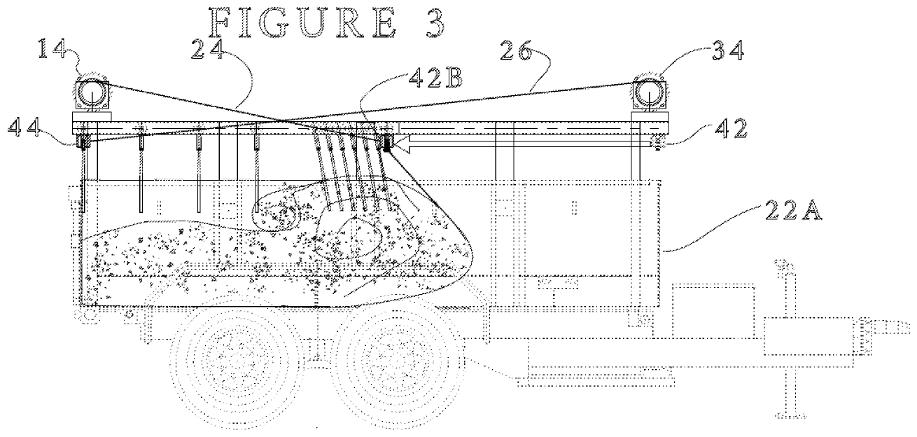

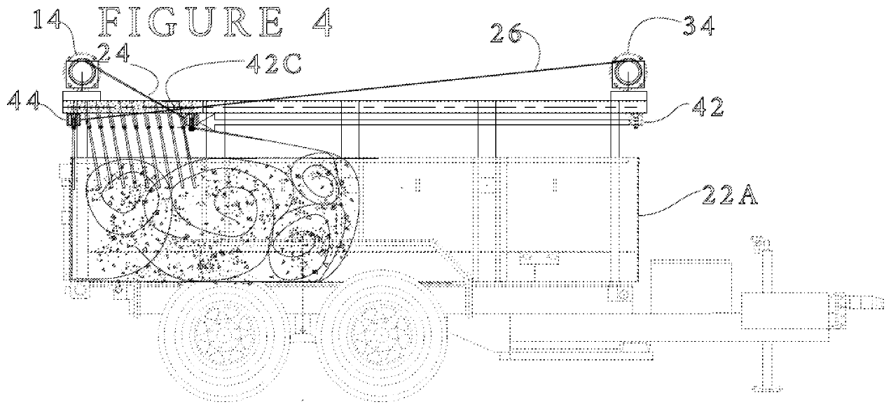

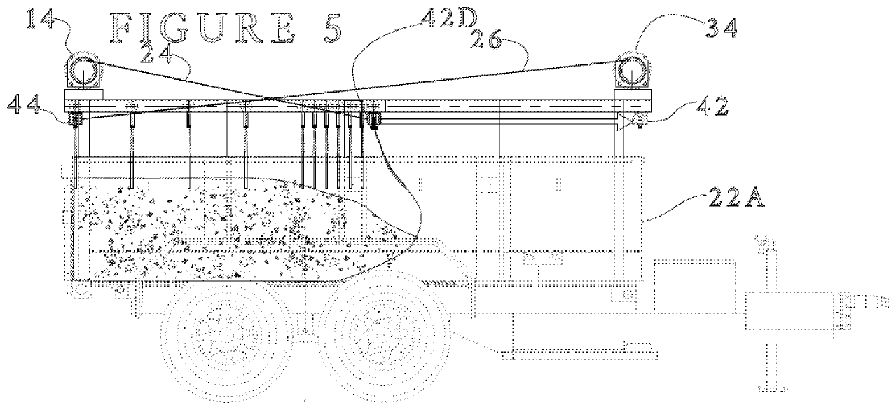

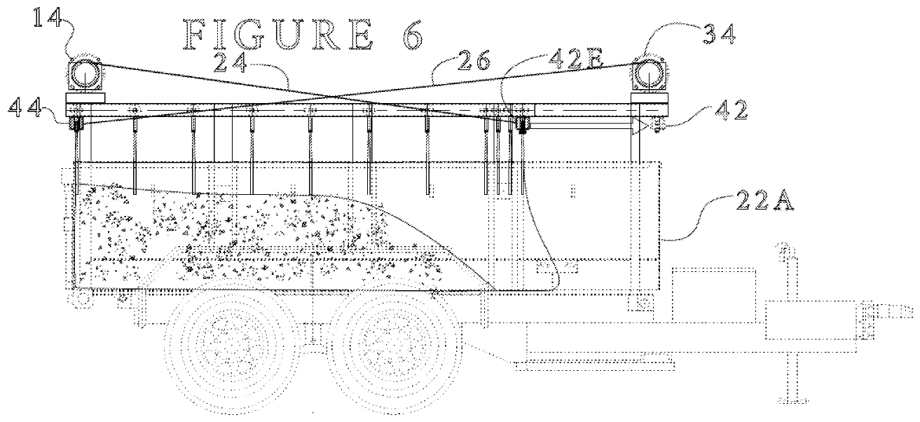

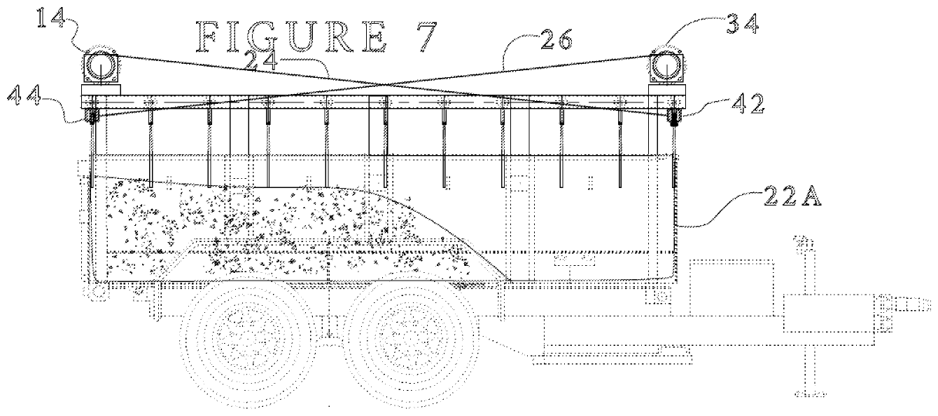

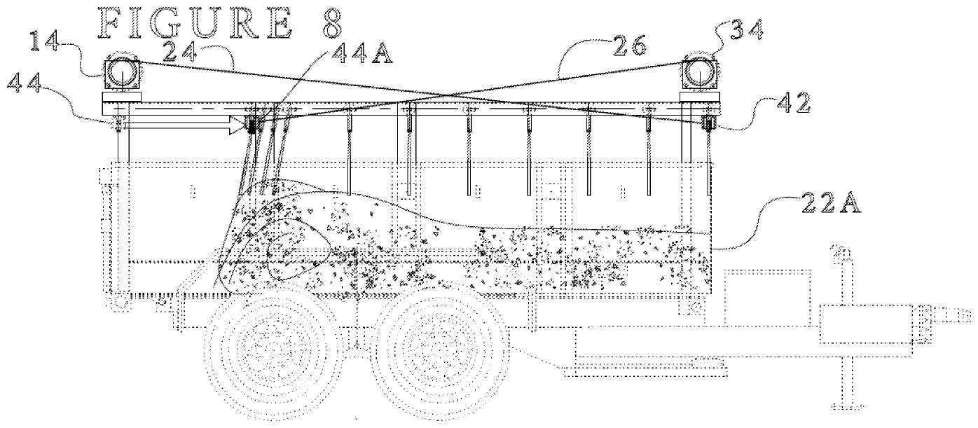

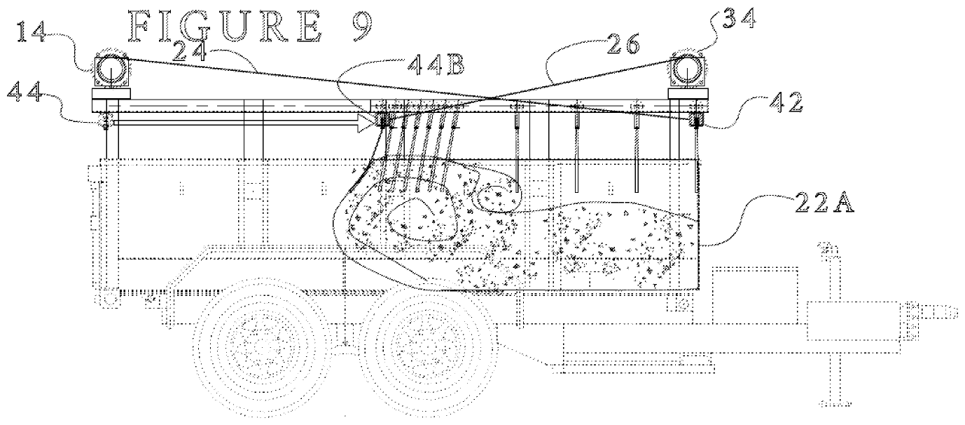

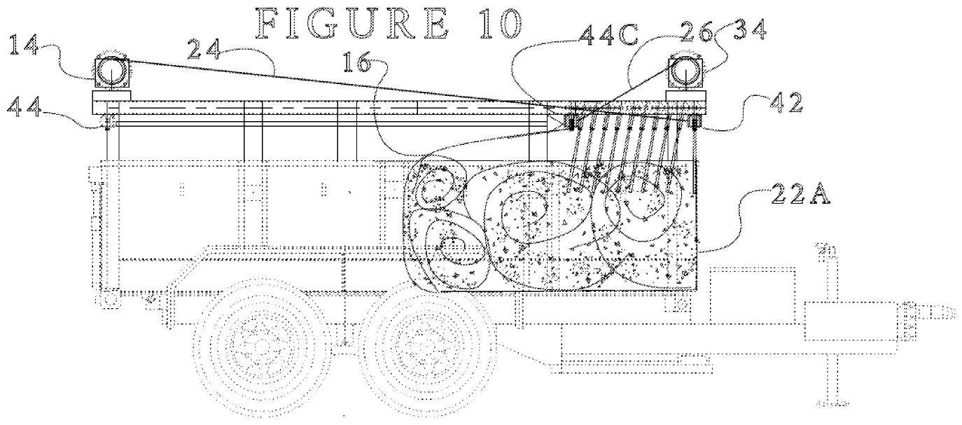

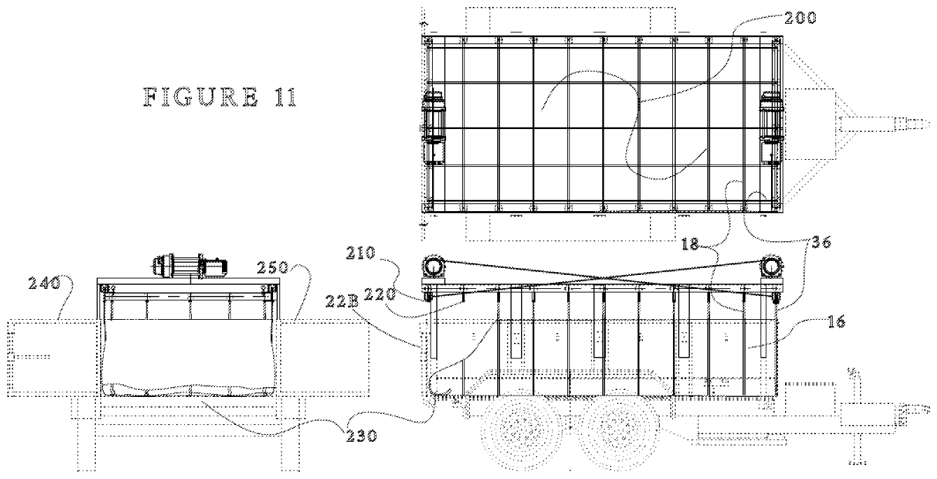

With reference to FIG. 1, it is apparent that the process is for mixing quantities of concrete onsite for mid to large range projects involving multiple yards of concrete with the ability to move the material with a dump trailer. The embodiments of these figures are not therefore to be considered to be limiting of its scope to a dump trailer or to just mixing concrete nor to the size of the container implied by FIG. 1.
FIG. 1 shows a dump trailer 22 having a container 22A with columns 30 inserted on the side column holders typically provided with most dump trailers, which run along the length of the trailer container or also known as a box. Although a dump trailer container or a box is shown in FIG. 1 the container can be round or of any shape, like triangular to allow funneling of the material and although the columns are shown mounted on the trailer, they can be freestanding directly on the ground, straddling a free-standing container and locked to the container by other means; further, the free-standing columns and rails in combination with the ground is a form of container for the suspended bag 16 and would not require a separate container to maintain the bag 16 in place. A rail system 42, 44 & 12 are attached to the columns 30 by welding or bolts or other mechanisms. Typical rail 12 are directly attached to typical columns 30 shown in FIG. 1, FIG. 1A and run the length of the box and are fixed. The type of steel rail depicted here is that typically used in overhead rails systems used to move components in a manufacturing process system, for example those provided by the company Unibilt®. Other types of steel rails, like I-beams with rollers not detailed here is another method which can be used to suspend the bag. The Unibilt rail mechanism 12 in FIG. 1A as detailed here allows for enclosed rollers and typical hanger plates 28 & 29. Movable rails 44 & 42, typically shown in FIG. 1A, 10, are attached to a hanging plate 28. Rail 10 may be fixed to rail 12 by means of a welded-on flange 48 and pin 46; other latch-locking mechanisms not detailed here may be used. A composite bag 16 is placed inside the trailer box and may match the dimensions of the trailer box. The bag is placed inside with the bottom of the bag at the bottom of the trailer with the vertical walls along the vertical walls of the box with the open side 40 up to receive material. The typical outward bag straps 36 & 18 are pinned 38 to the typical hanging plates 28 & 29. The typical straps 18 & 36 are made of suitable materials depending on the design of the bag, which may be nylon, leather and metallic and plastic composite and their design are based on the strength and design of the bag. A typical support spacing of straps 18 & 36 may be 1-foot, however, greater spacing may be suitable depending on the design of the bag. The straps in FIGS. 1 thru 10 are shown to extend only to a portion of the vertical drop from the bag 16 opening 40. This may be suitable based on the thickness and material type used to construct bag 16. FIG. 11 shows a strap grid pattern 200 not found in a commercial application and is a significantly more durable support grid pattern. The typical straps 18 & 36 in FIG. 11 are shown to run the full length and width of the bag and extending outward to be pinned at the looped end FIG. 1A, 38.
Mounted on center of the typical crossbeams FIG. 1A, 32 are the winches 14 & 34. The winch cables 24 & 26 attached to the respective opposite side of the movable rails 42 & 44. Although cables 24 & 26 are shown directly attached to the center of the movable rails 42 & 44, the pull direction, not shown in the figures or detailed here, may be redirected by pulleys to eliminate the pull at an angle.
FIG. 1 shows the completed embodiment assembly. Not necessarily in this order: the amount of concrete material 20 placed inside bag 16 should not exceed about half of the capacity of the bag 16 along with a portion of the required water.
FIGS. 2, 3 & 4 show the initial continuous pull by winch 14 through cable 24 attached to movable rail 42 to start the mixing process so that in a continuous-motion, moves rail 42 from its initial position to the positions shown 42A, 42B and 42C respectively. The end of the pull is at position FIG. 4, 42C, at about half the capacity of the box.
FIGS. 5, 6 & 7 show the release of winch 14 on cable 24 tension causing rail 42 to start the return to respective positions 42D, 42E & 42. The return of rail 42 is assisted by hand or other means.
FIGS. 8, 9 & 10 show the initial pull by winch 34 through cable 26 attached to rail 44 and causing it to continuously move to positions 44A, 44B & 44C, respectively. The end of the pull is at position FIG. 10, 44C, at about half the capacity of the box.
The respective bag end FIG. 10, 16 is returned by reversing actions shown on FIGS. 5, 6 and 7.
The balance of the desired water is poured in.
Actions shown on FIGS. 2 thru 10 and the bag reversing actions on FIGS. 5, 6 and 7 are repeated without adding water until the desired mixture is produced.
The bulk of the mixed concrete should end-up on the opposite side of the gates FIG. 11, 22B, before opening the gates 240, 250 for unloading. To unload the cement, the gates 240, 250 are opened and enough of the bag's typical supports 210, 220 on the end of the gate 22B are unlatched/unpinned to allow the end of bag 16 the to be folded under itself 230.

What is claimed:

1. A process of mixing materials consisting of sand like and gravel like hard materials, powdered like cement and water, like concrete or other similar materials, which method comprising of an embodiment of: a flexible industrial composite bag having a bottom, adjoining vertical sides with straps attached to the vertical walls around the perimeter of the bag at intervals suitable for the strength of the bag and its content and extending beyond the top of the opening; and the bag sized to match the container it is intended to fit; and bag and strap combination having the strength to support and contain the weight of the material dispensed inside the bag; the vertical sides of the bag are sustained by the outward straps extending a suitable length from the opening edge of the bag with the length end of the straps pinned to an overhead rail system set on columns adequate to support the weight of the rails, bag and materials, which, columns are set around the footprint of the bag; displacement of the sides of the bags by the movement of opposing overhead rails to cause the material to move in one direction and then return the bag end and then the same occurs for the opposite side of the bag in sufficient displacements as to cause turbulence and acceptable mixing of the materials contained within the bag.
